(19) United States
(12) Patent Application Publication
(10) Pub. No.: US 2024/0010009 A1
(43) Pub. Date: Jan. 11, 2024

(54) INKJET PRINTING METHOD

(71) Applicant: Kornit Digital Ltd., Rosh HaAyin (IL)

(72) Inventors: Allon SHIMONI, Modiin-Maccabim-Reut (IL); Jacob MANN, Zoran (IL)

(73) Assignee: Kornit Digital Ltd., Rosh HaAyin (IL)

(21) Appl. No.: 18/017,092

(22) PCT Filed: Jul. 22, 2021
(86) PCT No.: PCT/IL2021/050893

§ 371 Date: Jan. 20, 2023

Related U.S. Application Data
(60) Provisional application No. 63/057,961, filed on Jul. 29, 2020.

(51) Int. Cl. B41J 3/407; B41J 2/21; G06K 15/02; H04N 1/60

(52) U.S. Cl. CPC B41J 3/4078; B41J 2/2117; G06K 15/1836; H04N 1/6019

(57) ABSTRACT

Provided herein is a method for digitally printing an image on a fabric in the form of a film on the surface of the fabric, such that the film is characterized by improved properties over the entire image. The method is implemented by compiling in a test run a look-up table for at least one functional composition that confers a desired property to the image, and using the look-up table for printing any given image using just the optimal amount of the functional composition and only on portions of the image that require improvement.

### RELATED APPLICATION

This application claims the benefit of priority of U.S. Provisional Patent Application No. 63/057,961 filed 29 Jul. 2020, the contents of which are incorporated herein by reference in their entirety.

### FIELD AND BACKGROUND OF THE INVENTION

The present invention, in some embodiments thereof, relates to a method of inkjet printing, and more particularly, but not exclusively, to a method for digital inkjet printing on fabrics.

Printed textile has been in demand since the development of fabrics and dyes, and the digital era changed the way fabrics are decorated and designed, particularly through the development of inkjet technology adapted to fabrics. With the improvements on many aspects of textile printing, so did the popularity and requirements increased, and nowadays a printed piece of fabric is expected not only to present a colorful design thereon, but also be durable during use and repetitive washes, and have a pleasant hand feel, as well as other requirements. These requirements are typically met during the printing process, where the fabric, the inks and the printing process and machine all contribute to the desired result.

Currently, when setting up the system for a batch of textile printing, the general approach to industrial digital printing is empiric, namely based on the observation or experience of the operators, which require time and resources to bring the setup to optimal results. However, the time and cost invested in this empiric setup provides a limited result, as the setting applied to the machine does not take into consideration the particular features of the printed image itself, but rather treat the entire printing task as if the image is uniform, when in practice, unless the image is indeed featureless, each part of the image receives a different amount and combination of inks.

PCT/IL2018/051107, by the present assignee, which is incorporated herein by reference in its entirety, provides a method for digitally printing an image on a substrate in the form of a film attached to the surface of the substrate, such that the film is characterized by improved adhesion and fastness properties also in regions of sparse printing, the method includes digitally printing the image using colored ink composition(s) that comprises a particulate colorant and a binder, and digitally printing selectively a transparent colorless ink composition that includes a binder on regions of impaired adhesion of the image due to sparse printing, such that all parts of the image receive sufficient binding reagents according to a pre-determined threshold.

Direct inkjet printing on fabrics typically involves forming a film on the surface of the substrate such that the pigment particles are embedded in the film and the film is affixed to the substrate. Most properties of the image (film), such as color definition, resolution and gamut (typically referred to as image quality), film adherence and stability (typically referred to as wash fastness), smoothness/softness and other physical/mechanical properties (typically referred to as “hand feel”), are directly influenced by the amount and composition of the inks that are jetted onto the substrate during the printing process, while other properties are related to the type of substrate, optional pre-treatment it undergoes before printing, and post-printing process steps, such as curing.

Problems associated with inkjet printing liquid inks directly on absorptive substrates, such as textile and garments, have been mitigated in U.S. Patent Application Publication No. 20150152274, and PCT Application Nos. WO 2005/115089 and WO 2005/115761, by the present assignee that are incorporated by reference as if fully set forth herein. These documents teach a process, a composition and an apparatus for printing an image on an absorptive surface, such as an untreated (a substrate that has not been pre-treated chemically) textile piece, that includes applying a wetting composition on the surface which is capable of interfering with the engagement of a liquid ink composition with the binding sites of the surface. According to the processes taught in these patent applications, once the wetting composition is applied, the liquid ink composition is applied while the surface is still wet. Using this process, a vivid color image is formed on the absorptive surface. These patent applications, however, fail to address printing a color image on an absorptive dark surface.

Multi-part ink compositions, which are based on contacting an immobilizing composition and a colored ink composition on the surface of an untreated substrate, so as to congeal the colored ink composition on the substrate, thereby minimizing feathering and soaking thereof into absorptive substrates, are also taught in U.S. patent application Ser. No. 11/588,277 (U.S. Patent Application Publication No. 20070104899), and U.S. patent application Ser. No. 11/606,242 (U.S. Patent Application Publication No. 20070103529), all of which are incorporated by reference as if fully set forth herein.

Problems associated with inkjet printing transparent liquid inks directly on dark substrates, such as dyed textile and garments, have been mitigated in U.S. Pat. No. 7,134,749, by the present assignee, which is incorporated by reference as if fully set forth herein. This document teaches a method and an apparatus for color printing on an untreated dark textile piece that includes digitally printing, by means of an inkjet printer head, an opaque white ink layer directly onto the untreated dark textile piece, and digitally printing a colored image on the white ink layer.

U.S. Pat. No. 8,540,358, by the present assignee, which is incorporated by reference as if fully set forth herein, teaches an inkjet ink compositions for forming an image in a form of an elastic film attached to a surface of an untreated stretchable and/or flexible substrate and processes utilizing same for inkjet printing color images on various substrates such as colored and absorptive or impregnable stretchable materials, which are characterized by heightened efficiency in process time, ink and energy consumption, as well as products having durable, wash-fast and abrasion-fast images printed thereon by the process, are disclosed.

As presented hereinabove, inkjet printing on textile and other absorptive, flexible and stretchable substrates presents wide spectrum of challenges, including image resolution, color gamut, stretchability and robustness (adhesion to the substrate, wash-fastness as well as rub-fastness). The wash-fastness and rub-fastness of an image drives inter alia from the mechanical properties of the film, which is formed on the surface of the substrate because of the printing process.

In general, an image has regions of intense and less intense coloration and brightness, for example, near the edge of the image or in design elements that are fading into the background. These regions are formed on the surface of the substrate using fewer droplets of inkjet ink being jetted onto the surface; hence, these regions also receive a smaller amount of binder materials, compared to bright and/or intense colored regions in the image. Regions of such sparse printing oftentimes exhibit a thinner film, which exhibits a lesser adhesion power, compared to other regions in the film; in turn, these regions are more prone to peeling and discoloration because of wear and tear, and washing.

### SUMMARY OF THE INVENTION

According to an aspect of some embodiments of the present invention, there is provided a method of digital printing an image on a fabric, which is effected by:
digitally printing the image on the fabric using at least one color ink composition; and
digitally printing a pre-determined amount of at least one functional composition on at least a portion of the image, wherein:
the amount of the functional composition is determined for the portion based on an amount of the color ink composition in the portion;
the functional composition includes at least one functional agent.

In some embodiments, the portion of the image is defined by a raster image processor that controls a printing step of the image.

In some embodiments, the portion of the image that receives the functional composition, is one or more pixels of the image, as the image is rasterized and stored in a raster image processor information.

In some embodiments, digitally printing the image and digitally printing the functional composition are each effected at a different printing resolution.

In some embodiments, digitally printing the image and digitally printing the functional composition are effected essentially concomitantly.

In some embodiments, digitally printing the image is effected prior to digitally printing the functional composition.

In some embodiments, digitally printing the image is effected subsequently to digitally printing the functional composition.

In some embodiments, functional composition is suitable for a digital printhead.

In some embodiments, functional composition is essentially devoid of a colorant.

In some embodiments, the functional agent is selected from the group consisting of a softening agent, an adhesion agent, a rub-resistant agent, a friction-coefficient reducing agent, an optical brightening agent, a fabric-bleaching agent, a cross-linking agent, a dye migration blocking agent, and a matting agent.

In some embodiments, the method provided herein further includes generating a look-up table prior to digitally printing the image, wherein the look-up table is generated by:
digitally printing a gradient pattern on the fabric using the at least one inkjet color ink composition and the at least one functional composition, the gradient pattern includes a plurality of areas, each of the areas receives an amount of the color ink composition and an amount of the functional composition;
subjecting the fabric having the gradient pattern thereon to a functional test corresponding to the functional composition, and recording an optimal amount of the functional composition for each amount of the color ink composition, based on optimal result of the functional test, thereby generating the look-up table.

In some embodiments, the look-up table is generated for a given fabric and/or a given printing machine.

In some embodiments, the method provided herein further includes uniformly applying at least one functional composition on at least an area of the fabric corresponding to the gradient pattern or the image, prior to digitally printing the gradient pattern or the image.

In some embodiments, uniformly applying the functional composition is effected at a minimal amount that allows passing a functional test that is different than the functional test.

In some embodiments, method further includes drying the at least one functional composition prior to the digitally printing the gradient pattern or the image.

In some embodiments, digitally printing the image includes applying an immobilizing composition on the fabric.

In some embodiments, the immobilizing composition is a functional composition.

In some embodiments, the immobilizing composition is not a functional composition.

In some embodiments, the functional composition is devoid of a binder, an adhesion promoting agent and the like.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### DESCRIPTION OF SOME SPECIFIC EMBODIMENTS OF THE INVENTION

The present invention, in some embodiments thereof, relates to a method of inkjet printing, and more particularly, but not exclusively, to a method for digital inkjet printing on fabrics. The principles and operation of the present invention may be better understood with reference to the accompanying descriptions.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

As presented hereinabove, the textile industry enjoys the benefits of the digital era through inkjet printing in an increasing rate, while at the same time the requirements posed on the finished product also increase. Direct digital inkjet printing of inks comprising particulate colorants on untreated fabrics has enjoyed the improvements provided by the aforementioned technologies, since the emulsified and/or suspended colorant particles are required to be affixed to the substrate by means of film-forming agents (adhesion agents and/or binders), forming a transparent film that binds the colorant particles while adhering to the substrate; in cases where the substrate is not white, the process is supplemented by an opaque white underbase layer. Some of the aforementioned technologies utilizing property-sensitive variants of emulsified film-forming adhesion agents and film-forming binders and/or dispersants of the suspended colorant particles, wherein these variants can lose their solubility in the ink's medium when contacted with a property-adjusting agent (e.g., an acid), and thereby cause coagulation of the ink composition on the surface of the substrate. In addition, the aforementioned technologies are based on the ability to crosslink the various ingredients of the film amongst themselves and with the substrate, which is obtained by using a crosslinking agent which cures the film at elevated temperatures. None of the aforementioned technologies and methodologies provide a solution to the problem of homogeneity in the desired properties of the finished film constituting the image.

The present inventors have recognized that indiscriminant addition of certain functional agents during the printing process may improve some of the problems arising from non-homogeneous printing, but at the expense of forfeiting some of the most important advantages of inkjet technology, since indiscriminant addition of some agents to the entire area covered by the image will augment the film needlessly in some, or in most of its area. In addition, the printing process will take more time and run up costs. In addition, in view of the raise in awareness to sustainability, indiscriminant addition of chemicals, which also means greater amounts of chemicals, is not recommended. In addition, excess application of any liquid composition, which is typical to homogeneous indiscriminant application of liquids on a fabric substrate, adds to the energy consumption of the printing process, due to the need to drying and curing the printed substrate.

As would be reckoned by the skilled artisan, each type of fabric requires a different machine setup, and in some cases, a different set of inks, pre-treatment and post-treatment of the printed design in order to stand by these requirements. While conceiving the present invention, the inventors have contemplated a general methodology to digital textile printing that will serve all printing machines, all fabrics and all printed design and task—the main purpose of the present invention is to generalize the optimization of the printing process while taking into account not only the machine and the fabric, but also the features of the image.

Terminology and Definitions

The color mixing method commonly used in printing is known as subtractive primary colors model. Typically, an inkjet printing system includes a set of colored ink compositions, one for each of the primary colors used to create an almost complete spectrum of colors, or color space. The most commonly used in printing is the CMYK color model. The black is referred to as “K” for key (shorthand for the printing term “key plate” which was used to impress the artistic detail of an image, usually in black ink). “C” stands for cyan; “M” stands for magenta and “Y” stands for yellow.

Opaque inks reflect light wavelengths, while transparent inks transmit light wavelengths to the object's surface. The term “transparent”, as used herein, refers to an ink, a material or an article, allowing light to pass through so that objects behind can be seen; the term “transparent” is used in the sense of translucency, the physical property of allowing the transmission of light through a material. The term “opaque”, as used herein, refers to an ink, a material or an article, which is not transparent, namely not able to be seen through. Therefore, when using transparent ink compositions, the color of object's surface has a principal influence on the perceived color, and thus is usually opaque white, or at least lightly colored. In that case, the viewer receives the reflected light from the substrate. For example, if a white substrate is painted with pure blue transparent ink, the ink layer absorbs the ambient light, allowing only the blue light to be transmitted to the substrate. The blue light is then reflected by the opaque white substrate, back through the ink and into the viewer's eyes, and perceived by the viewer as blue color.

The term “colorless”, as used herein in the context of an ink composition, refers to an ink composition lacking an addition of a colorant. In other words, a colorless ink composition imparts no color on the substrate and makes no, or marginal difference in term of color when added to, or printed near another ink composition. In the context of Lab color space (CIELAB), a colorless ink composition is characterized by imparting to a receiving substrate infinitesimal a* and b* values, or very low a* and b* values.

As used herein, the term “CIE Lab”, “L*a*b*” or “Lab*” refers to the CIE L*a*b* (International Commission on Illumination or Commission Internationale d'Eclairage (CIE)) color model. Used interchangeably herein and throughout, CIE L*a*b*, L*a*b* or Lab is the most complete color model used conventionally to describe all the colors and shades which are typically visible to a normal human eye. The three parameters in the model define a particular color, whereas the lightness of the color is represented by the parameter L*, wherein L*=0 corresponds to black and L*=100 corresponds to white. The value between true magenta and true green is represented by the parameter a*, wherein a negative value indicates green and a positive value indicates magenta. The value between true yellow and true blue is represented by the parameter b*, wherein a negative value indicates blue and a positive value indicates yellow.

In the context of the present invention, a colored ink composition can be a standard colored inkjet composition or a modified version of a standard inkjet composition, and can be any transparent/translucent colored liquid ink composition, any semi-transparent colored liquid ink composition or any opaque colored liquid ink composition. Preferably, the colored ink composition comprises one or more colorants, and more preferably, the colorant is a particulate colorant, such as pigments and/or dye-encapsulating particles. According to some embodiments, the colored ink composition is formulated to comply with the requirements imposed by the inkjet printhead and other machinery parts, such as viscosity, corrosion, particles, wetting and the like.

The term “colorant”, as used herein, describes a substance, which imparts the desired color to the printed image. The colorant may be a particulate colorant or a dye. Particulate colorants are solid particles characterized by an intense and dense color that can be affixed to a substrate typically as part of a film made from a resin and/or film-forming binders and/or adhesion-promoting agents and/or crosslinking agents. Pigments are solid particulate colorants having a distinct color, which are typically suspended/dispersed in the carrier of the ink composition, whereby dyes are liquid colorants, which are dissolved or emulsified in the carrier of the ink composition. According to embodiments of the present invention, the colorant is a solid colorant in the form of a dispersed pigment. According to some embodiments of the present invention, the colorant is a solid dispersed particle shell (e.g., silica, polymeric or otherwise) encapsulating a dye (e.g., an organic dye molecule, a fluorescent dye and the likes), that is otherwise insoluble or indispersible in the ink's medium.

RIP data contains the information relating to the digital rendition of the image, and may including a bitmap, pixel resolution, overall coverage area (silhouette), external and internal edges, background color, process color composition, color management profile and the like; this information is used by the printing machine to determine where and how much of each process colored ink composition to inkjet at each area unit (pixel). In some embodiments, analysis of the RIP data is effected at the resolution of the bitmap of the RIP, namely the mapping is at the resolution level of the image as it is digitized and stored in the RIP. The smallest unit area is typically referred to as a pixel, and it is the resolution at which the printing machine is operated to form the image. In other words, a printing area unit is defined by the area unit that corresponds to the resolution of the printing machine, wherein the smallest digitally analyzable and treatable (printable) area unit is one pixel.

A method of printing:

According to an aspect of the present invention, there is provided a method for digital printing an image on a fabric, that involves the use of one or more specific functional compositions that are added to the image during the digital printing process using one or more standard or specialized ink compositions, wherein the type and amount of each of the functional compositions are set based on the features of the particular image, namely the location and amount of the functional compositions is determined based on the total amount of ink compositions at any given portion of, or location in the image.

The present invention provides the means to determine the amount of each of the functional compositions, to be printed on each part of the image, based on a look-up table that is generated during a test run, whereas the test is run at least once for each combination of machine and fabric. The test run is effected by printing a gradient patters by the printing machine on the fabric, subjecting the printed and cured gradient pattern to at least one test, measuring a property of interest therein, and storing the results of the test in a look-up table wherein the amount of ink(s), the amount of functional composition(s) and the result of the test are used during the printing of any image on the same printer and fabric.

In some embodiments of the present invention, the color/process ink composition(s) and the functional composition(s) are printed concomitantly, which in the context of the present invention means “at the same time” or “almost at the same time”. In the context of the present invention, the term “concomitantly” is used to state that the color ink and functional compositions are both printed during the printhead deployment step of the process, before drying and/or curing the image on the fabric, and that there is no limitation as to the order by which the compositions are printed. This order may be a result of the arrangement of the printheads on the printer's rig, or the order by which the printheads are commanded to deploy by the machine controller.

In some cases, one or more functional compositions can be applied uniformly on the fabric in order to set a different (higher) base-line level of the particular functional compositions, whereas the rest of the method is effected as described herein. A higher base-line level of any given functional composition, which is applied on the fabric indiscriminately with respect to the features of the image to be printed thereon, may be needed in cases where the fabric is known a priori to require a higher amount of the functional agent to be present throughout the entire area on the image. This printing step is effected by nozzles or sprayers that cover a large area at a short time, thereby saving time during the step of ink composition printing. The method presented herein is designed to refrain from impairing the hand feel and/or breathability of the finished product, and particularly that of the image's surface, and is further designed to render the printing process efficient in terms of printing time, material and energy usage—hence, uniform application of a functional composition is minimized intentionally.

According to some embodiments of the present invention, the method is further implemented by digitally analyzing the image prior to its printing in order to correlate a look up table (LUT) to the image's features. A digital analysis of the image prior to its printing may be executed by using the RIP (Raster Image Processor) information as input for an image analysis and processing algorithm. The RIP is a digital form of the image that can be processed by a computer-borne algorithm, and includes pixel position data and color-per-pixel information, namely the total amount of the colored ink composition(s) per each pixel of the image.

According to some embodiments of the present invention, every portion of the image is defined by a raster image processor that controls a printing step of the image, including the portion that is intended to receive a functional correction, based on the LUT. In the context of the present invention, that portion of the image is defined by one or more pixels of the image as stored in a raster image processor information.

In some embodiments, the printing method further includes applying or printing an immobilizing composition on the surface of the substrate, at least in the area(s) on which the image is printed, as disclosed in any of U.S. patent application Ser. No. 11/588,277 (U.S. Patent Application Publication No. 20070104899), U.S. patent application Ser. No. 11/606,242 (U. S. Patent Application Publication No. 20070103529), and U.S. Pat. No. 8,540,358, all of which are incorporated by reference as if fully set forth herein.

In some embodiments, the method further includes applying homogeneously, over the entire printed area of the fabric, a pretreatment composition that include at least one functional agent, such as a binding agent, followed by curing and/or drying the pretreatment layer on the fabric. For example, the pretreatment composition is intended to change the absorption of the surface of the fabric in order to reduce ink penetration into the fabric, which reduces the quality of the printed image due to feathering.

In some embodiments, the printing method further includes printing an opaque white underbase ink composition on the surface of the substrate, at least in the area(s) on which the image is printed of, particularly when inkjet printing transparent liquid colored ink compositions on dark substrates, as disclosed in U.S. Pat. No. 7,134,749, which is incorporated by reference as if fully set forth herein.

In some embodiments, the printing process, according to the method provided herein, is completed by curing (drying, heating and/or irradiating) the wet image to obtain the image in the form of a film attached to the surface of the substrate.

Functional Composition:

In the context of the present disclosure, the term “functional composition” refers to a liquid composition that contains a functional agent, which when applied on the fabric and/or the printed image thereon, confers an effect on the finished product (a cured image on the fabric) that can improve the quality of the product in a perceivable way, qualitatively and/or quantitatively. A functional agent, in the context of the present disclosure, is typically a chemical substance that interacts with the fabric, the liquid ink composition(s) or both, such that the finished product is improved by at least one of the following properties:
The ink has not soaked into the fabric and stained its backside (no bleeding to the backside) during the printing process and prior to curing the image/film; The resolution, color gamut, sharpness, etc. (image quality) is as high as possible by the machine and less affected by the fabric's texture;
The cured film attached to the fabric's surface, is more durable in washes (wash fast) or daily use (rub resistant);
The finished product is smooth, soft and breathable (hand feel);
The finished image is brighter or shinier or less shiny (light reflectance).

It is to be understood that the invention is limited to the abovementioned properties, but can be extended to any property that can be enhanced, preserved or reduced to the desired level thereof by using one or more functional composition containing one or more functional agents.

A “functional composition”, as this term is used herein, can be applied by a nozzle or a printhead, namely it is adjusted to exhibit the mechanical/physical properties of a jetable composition in the context of a digital inkjet printhead, or at least a nozzle or a sprayer that can be controlled by the printing machine. In some embodiments, the functional composition is formulated to be suitable for a digital printhead. It is to be understood that the functional composition is intended for application in the form of droplets, as opposed to screen-printing compositions that are intended for use as a paste by smearing. The functional composition, according to some embodiments of the present invention, is also intended for application digitally (accurate positioning and dosing by the printing machine controlling units) with correlation to the features of the image, as well as by a spryer that covers a larger area at a shorter time, yet applies the functional composition indiscriminately with respect to accurate positioning and dosing, and regardless of the features on the printed image.

In the context of embodiments of the present invention, a functional composition, comprising a functional agent, is formulated and added during the printing process in order to confer a functional correction to at least some part(s) of the image (while other parts may not require the functional correction). An exemplary functional correction is the betterment of a hand-feel in parts of the image that receive a relatively large amount of a color ink composition (a process ink), which causes the image to be rough at these parts of the image, whereas the functional correction is effected by adding (more) softener composition at these parts.

In some embodiments of the present invention, the functional composition is essentially colorless in the sense that it does not contain a pigment or a dye that is intended to add color to the printed image. In some embodiments, the functional composition is formulated to be essentially devoid of a colorant.

In some embodiments, the functional composition is an immobilizing composition, as described, for example, in U.S. patent application Ser. No. 11/588,277 (U.S. Patent Application Publication No. 20070104899), U.S. patent application Ser. No. 11/606,242 (U.S. Patent Application Publication No. 20070103529), and/or U.S. Pat. No. 8,540,358.

It is noted herein that the use of one functional composition which has a desired effect in terms of one functional test, may have an undesired effect in terms of another functional test, when used in excess. For example, as an immobilizing composition confers a desired effect on the image quality by mitigating feathering of the liquid ink in the absorptive fabric substrate, however, when used in excess, the immobilizing composition may in some cases loosen the bonding force between the film (the image) and the fabric, which is expressed in poor wash fastness test results. Hence, in some embodiments, there is a limit on how much any one functional composition can be effective before it adversely affects another functional parameter.

It is further noted herein that some functional corrections are in higher demand, and are more likely to be needed than other functional corrections, and the functional compositions that are used for these functional corrections are referred to herein a major functional compositions, whereas other functional compositions are referred to herein as secondary functional compositions. An example of a major functional composition is an immobilizing composition, which is more likely to be used than others since all colored ink compositions printed on the entire fabric are prone to feathering. A secondary functional composition may be a binder composition, which may be needed in parts of the image that receive less color ink compositions that other parts thereof, or a softener composition that is needed in parts of the image that receive more ink compositions that other parts thereof.

Functional Agents:

A functional agent, as this term is used herein, is defined as a substance that when printed on the fabric as part of the image printing process, is capable of correcting at least one property of the finished product. This at least one property of the finished product is adversely affected by the total amount of ink that is received on any given portion of the image (excess or deficiency), and therefore is not homogeneous across the image's area—the method provided herein provides a general solution to this non-homogeneity.

Exemplary functional agents include, without limitation, softening agents, adhesion agents, rub-resistant agents, friction-coefficient reducing agents, optical brightening agents, fabric-bleaching agents, crosslinking agents, dye migration blocking agents, and matting agents.

Non-limiting examples of softening agents include silicone base softeners;

Non-limiting examples of adhesion agents include acrylic based binder, urethanes based binders, and crosslinking agents;

Non-limiting examples of rub-resistant agents include waxes; Non-limiting examples of friction-coefficient reducing agents include siloxane based agents;

Non-limiting examples of optical brightening agents include stilbenes, coumarins, imidazolines, and diazoles;

Non-limiting examples of fabric-bleaching agents include sulfur-based reducing agents, and chlorine based agents;

Non-limiting examples of crosslinking agents include carbodiimide, isocyanate, and polyisocyanate;

Non-limiting examples of dye migration blocking agents include active carbon; and Non-limiting examples of matting agents include polymethylurea, silica based agents, and waxes.

Functional Tests:

Each of the functional agents contributes to at least one property of the finished product, such as color gamut, light reflectance, film adhesion and fastness, film softness, rub-resistance, friction coefficient, and the like. As presented hereinabove, a gradient pattern is printed, cured and subjected to a functional test that is relevant to the functional agent contained in the functional composition used in forming the gradient pattern. For example, the functional test to which the gradient pattern, comprising a binder (adhesion promoting agent), is subjected to, is a wash fastness test. The fabric is printed on, the image (gradient pattern) is cured, and the fabric having a cured image thereon is washed in a washing machine according to a specific or standard wash-fastness protocol, which gives a numerical value to each of the parts of the gradient pattern.

In the context of embodiments of the present invention, wash fastness, color fastness or simply fastness, refers to the resistance of printed image to fade due to the influences of various factors, such as water, light, rubbing, washing, perspiration etc., to which the printed substrates are normally exposed in manufacturing and in daily use. Types of color fastness include wash fastness, rub fastness, light fastness, perspiration fastness, water fastness, and color fastness to bleaches and chemicals.

In the context of some embodiment of the present invention, standard color fastness includes wash fastness and rub fastness, which are mostly affected by the level of adhesion of the film to the fabric. In general, any type of fastness can be assessed and tested for qualifying a desired standard, using a color fastness testing method; a printing result obtained from any given combination of printing process parameters, ink composition and substrate, can be tested for any color fastness criteria, whereas passing a fastness test is indicative of using sufficient amount of ink or binder at the tested region.

It is noted that any color fastness testing method is applicable in the context of some embodiment of the present invention, including proprietary and publically available methods, as well as standard methods known in the field of textile and printing.

Standard test methods for color wash fastness include, without limitation:
1. AATCC Test Method 61-Test No. 1A or Test No. 2A;
2. ISO Test Method 105 C-06-1A or 2A; and
3. CAN/CGSB Test Method 19 (#2).
   Standard test methods for color fastness to rubbing include, without limitation:
1. ISO 105-X12 2002: Color fastness to rubbing;
2. ISO 105-X16: Color fastness to rubbing;
3. AATCC 8:2005: Color fastness Crocking;
4. AATCC 116-2005: Color fastness to Crocking; and
5. AATCC 165-1999.

In the context of embodiments of the present invention, fastness can be determined based on an arbitrarily fastness score set by the user, or based an acceptable fastness score that complies with any fastness scoring methodology, such as the abovementioned fastness standards. The same concept holds for other measurable and controllable properties of the finished products that can be modified by using a functional composition, namely for softness, color quality, and light reflectance, for example.

Gradient Pattern:

The process is generalized for each machine and fabric combination by utilizing a look-up table that is obtained once for each machine (including the ink compositions used by the machine) and fabric combination, and us suitable for all images and designs as long as the machine and fabric stay constant.

At the basis of the method lies a test run, in which the machine of choice is loaded with the fabric of choice, and a gradient pattern is printed thereon using some or all the inks to be used by the machine (typically a CMYK ink set for white fabrics, plus an opaque white underbase ink for non-whites), as well as some or all the functional compositions that are available and/or required. The gradient pattern is formed by printing a series of shapes (e.g., squares) using an incremental amount of inks and functional compositions for each shape, such that the resulting gradient pattern includes at least one sample (shape) printed for each combination of inks and functional compositions increment, whereas the number (size) of increments and the number of compositions is determined a priori by the operator, and are limited by practical considerations but not by the concept of the present invention.

The gradient pattern can be easily represented by a table, such as Table 1, presented in the Examples section that follows below, which is an exemplary representation of a test run using two parameters, one colored ink composition and one softener functional composition, aimed at mitigating the hand-feel of the print which is degraded as more white ink is used. The values of the table headers are jetting coverage in percent, namely the amount of ink is expressed in terms of surface coverage, which is typically a characteristics of the machine, and thereby the machine's properties are incorporated into the test run. The amount of the different inks can be represented in other terms, such as weight per area, number of droplets per raster/pixel, and any other form of inkjet printing parameters that are known to the skilled artisan.

The gradient pattern can include more than two parameters, and can be represented, for a non-limiting example, by a series of 2-parameter (2-dimensions; 2D) tables, each having a different value of a third parameter, and together the set represents a 3D gradient pattern. For example, a set of the above Table 1, wherein each of the tables in the set represents an increment of another functional composition or another ink composition.

Alternatively, the gradient pattern can be formed by using a combination of compositions in one of the dimensions; for example, a combination of more than one colored ink compositions versus one functional composition.

Further alternatively, in order to reduce the tests prior to print the final print, the gradient pattern can be reduced to the minimum required by the user, the user may, for example, choose to test only one functional ink percent coverage in order to decide where to apply a functional ink.

Look-Up Table:

The test run is used to form a look-up table (LUT), which is stored in the printing machine's computerized controller, and is referred to for printing any design or image, as long as the fabric and the machine are the same as those used to form the LUT. Once the gradient pattern is subjected to the functional test, the LUT is populated with select data entries that will be used (referred to) during the printing process.

The population of the LUT is carried out as follows: each shape of the gradient pattern is given a functional test score—an absolute or relative value resulting from the functional test. Each entry of the LUT, according to some embodiments of the present invention, contains the amount of ink composition, functional composition and a functional test score that may represent an optimal result (“best”, “cheapest”, “fastest”, “acceptable”) result, wherein the operator of the printing machine may choose to the refer to (work with) one type of optimization definition or another. In some embodiments, the optimal amount of any given functional composition is the minimal amount that affords the desired functional result.

Thereafter the printing process continues with analysis of the RIP data pertaining to the printed image of choice, and each data entry of the RIP is associated with a corresponding entry in the LUT, thereby correlating the optimal amount of any given functional composition to the amount of ink composition printed in each pixel. In some embodiments of the present invention, the RIP data includes the values stored in the LUT.

The term resolution in the printing mean how many dots (droplets of ink—can be called pixel) per lengths unit, mostly represented by DPI— dots per inch, mostly the units are i-times-j DPI meaning i dots in one direction and j dots in the perpendicular direction.

In some embodiments, the colored (process) ink compositions are printed at a resolution that is different than the resolution used to print the functional compositions. This difference can be expressed in the operation resolution of the colored ink printheads, compared to the operation resolution of the functional compositions. Thus, the image can be formed by printing the colored ink composition at a different resolution compared to the printing resolution of the functional composition. In embodiments where the resolution of the functional composition is smaller than the resolution of the colored ink composition, the functional compositions can be printed at a faster rate than the image. In some embodiments the resolution of the functional composition is different than the resolution of the image in order to deposit different quantity of the functional composition on the selected area. In the context of some embodiments of the present invention, the resolution of the colored ink compassion(s) is similar to the resolution of the functional compositions.

In some embodiments, the colored (process) ink compositions are printed at a drop size that is different than the drop size used to print the functional compositions. The drop size is determined by the printhead in use, by the pulse designed to discharge the ink form the inkjet the like.

Method's Algorithm:

The method provided herein can be implemented by following an algorithm, as presented hereinbelow. The algorithm is compiled under the assumption that any image printed on the fabric will require at least some functional correction in at least some parts thereof. The algorithm presented hereinbelow is a non-limiting exemplary of the method implemented for a single functional correction—it is noted that the method encompasses a broader concept in which more than one functional correction is needed and effected in the same or similar fashion.
▾ Given a printer and a fabric, load the printer with the fabric, and print a gradient pattern for one color ink composition (process ink) and one functional composition (one functional agent), and cure the image;
▾ Subject the cured image to a functional test, and analyze the results to determine sufficiency of the functional agent across the entire range of process ink amounts;
[symbol] If a maximal amount of the functional composition did not achieve acceptable results at any extreme of the range of process ink amount, meaning amount insufficiency, pre-treat a fresh fabric homogeneously with the functional composition at an amount equivalent to mid-range of the gradient pertaining to the functional composition, and repeat the test run;
[symbol] If the functional test showed acceptable results across the entire range of process ink amount, generate a look-up table pertaining to the functional composition for the given printer and fabric;
▾ Load the printer with the look-up table, process ink, functional composition and the fabric, and print an image, wherein the image is generated with a combination of the process ink and the functional composition.

In other words, the algorithm is effected by testing the fabric's response to the printer and inks in a first test run that will enable the user to decide whether the fabric is within the range that can be functionally corrected by printing functional composition(s), or to pre-treat the fabric homogeneously (e.g., by spraying) prior to the printing task. The pre-treatment can optionally include drying/curing the pre-treated fabric, or alternatively the process can continue to printing in-line of the homogeneous application of the functional composition, while the fabric is still wet with the functional composition. Once the test run shows that the functional correction is achieved within the range of printing amounts, a look-up table is generated from the results of the test run, which is used thereafter for any image that is printed on the same type of fabric and printing machine.

The algorithm presented hereinabove is useful also in the case of two functional compositions with contradictive or otherwise conflicting effects. In such cases, the test run is conducted using a three-parameter gradient pattern. Alternatively, a first test run is conducted with the major functional composition, and a second test run is conducted for the secondary functional composition, wherein the second test run comprises a fixed amount of the major functional composition.

It is expected that during the life of a patent maturing from this application many relevant methods for inkjet printing of wash-fast images with improved film adhesion will be developed and the scope of the term “methods for inkjet printing of wash-fast images” is intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the phrases “substantially devoid of” and/or “essentially devoid of” in the context of a certain substance, refer to a composition that is totally devoid of this substance or, in the alternative, includes less than about 5, 1, 0.5 or 0.1 percent of the substance by total weight or volume of the composition. Alternatively, the phrases “substantially devoid of” and/or “essentially devoid of” in the context of a process, a method, a property or a characteristic, refer to a process, a composition, a structure or an article that is totally devoid of a certain process/method step, or a certain property or a certain characteristic, or a process/method wherein the certain process/method step is effected at less than about 5, 1, 0.5 or 0.1 percent compared to a given standard process/method, or property or a characteristic characterized by less than about 5, 1, 0.5 or 0.1 percent of the property or characteristic, compared to a given standard.

The term “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The words “optionally” or “alternatively” are used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the terms “process” and “method” refer to manners, means, techniques and procedures for accomplishing a given task including, but not limited to, those manners, means, techniques and procedures either known to, or readily developed from known manners, means, techniques and procedures by practitioners of the chemical, material, mechanical, computational and digital arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental and/or calculated support in the following examples.

### EXAMPLES

Reference is now made to the following examples, which together with the above descriptions illustrate some embodiments of the invention in a non-limiting fashion.

### Example 1

A proof of concept of some embodiments of the present invention was carried out by printing an image using immobilizing (acid) composition as a functional composition to achieve optimal results in term of ink soaking, color intensity and wash fastness.

It has been found that while arresting ink soaking into the fabric, excess of immobilizing composition may result in poor wash fatness, while lack of immobilizing composition will result in low color intensity.

Spraying the entire area of the image by a nozzle that applies large coarse drops of relatively cheap immobilizing composition at great speeds may seem advantageous, however, the fabric may show stains or discoloration in areas of the fabric that are not covered by an image, and albeit not expensive compared to an immobilizing composition formulated for a printhead, homogeneous spraying is more wasteful than precise digital jetting on problematic areas only, and requires longer drying/curing times.

Using precise digital printing of an immobilizing composition formulated for a printhead allows to improve color intensity, since the colored ink composition mixes with the immobilizing composition while the drops of both compositions are still on top on the surface, and the immobilized ink drop is more exposed and thus perceived more intensely. Digital jetting of the immobilizing composition also allows to apply variable amounts that correspond to the amount of ink composition in various parts of the image. For example, larger amount of the immobilizing composition is in parts that receive relatively larger amount on colored ink compositions, whereas parts of the image that receive less of the colored ink compositions may exhibit lower wash fastness if the same amount of immobilizing composition will be applied thereon.

It is therefore advantageous to determine the minimal amount of immobilizing composition that can be applied homogeneously over the entire area of the printed image that can achieve ink soaking arrest, and then determine the optimal additional amount of the immobilizing composition that will improve color intensity without impairing wash fastness.

In the first run, the amount of the homogeneously applied immobilizing composition was determined by nozzle-spraying an immobilization composition comprising an acid at different quantities, ranging from 0.04 gr/inch2 to 0.3 gr/inch2 on a black garment (PROMODORO 3099), and thereafter printing a full covering (100% surface coverage) of a white ink composition. The cured fabric was inspected for signs of white color on the back side of the fabric, as well as feathering of the while ink more than 300 microns away from the image's perimeter.

It was determined that for the specific fabric and printer, the minimal amount of the immobilizing composition is about 0.16 gr/inch2. The spraying and printing were performed on a Kornit Digital's ATLAS printer using drop size of about 35 pl at a resolution of 400*600 DPI.

Following the previous test run, the same fabric was sprayed homogeneously with 0.16 gr/inch2 of the immobilizing composition, and then used to print thereon a gradient pattern using the same white ink composition, wherein one axis of the gradient was a white ink coverage ranging from 5% to 100%, and the second axis of the gradient was of the immobilization composition (the functional composition) ranging from 0 (no immobilization composition) up to 200% coverage. To achieve 200% coverage, two printheads were used to print the immobilization composition so at each pixel was able to receive two drops of the functional composition.

The gradient pattern was cured and subjected to color intensity test and wash fastness test, and the results are presented below.

Table 1 presents the L* value in the Lab color analyzing protocol representing the level of whiteness as a function of the amount of white ink versus the amount of the functional (immobilizing) composition.

TABLE 1

| White | | | | | | | | | | | |
|---|---|---|---|---|---|---|---|---|---|---|---|
| ink % | Immobilization composition % coverage (printed by a printhead) | | | | | | | | | | |
| coverage | 0 | 20 | 40 | 60 | 80 | 100 | 120 | 140 | 160 | 180 | 200 |
| 5 | 30.95 | 31.01 | 30.56 | 29.79 | 30.18 | 29.41 | 31.34 | 30.12 | 30.41 | 30.02 | 30.06 |
| 20 | 57.35 | 59.39 | 59.68 | 58.6 | 58.8 | 58.2 | 59.09 | 58.23 | 58.62 | 58.66 | 58.23 |
| 40 | 62.41 | 71.52 | 77.25 | 77.82 | 78.02 | 77.54 | 78.16 | 77.6 | 77.95 | 77.71 | 77.9 |
| 60 | 55.75 | 69.55 | 78.63 | 82.82 | 83.74 | 83.87 | 85.16 | 85.37 | 85.55 | 85.39 | 85.48 |
| 80 | 47 | 63.96 | 76.94 | 84.34 | 86.45 | 86.79 | 88.48 | 89.06 | 89.12 | 89.22 | 89.07 |
| 100 | 42.43 | 54.28 | 71.87 | 83.08 | 87.01 | 88.26 | 90.2 | 90.68 | 91.04 | 91.23 | 90.97 |

Table 2 presents the qualitative wash fastness arbitrary values ranging from 1 (poor) to 5 (good) as a function of the amount of white ink versus the amount of the functional (immobilizing) composition, wherein a value from 4.5 is acceptable in the context of this example.

TABLE 2

| White | | | | | | | | | | | |
|---|---|---|---|---|---|---|---|---|---|---|---|
| ink % | Immobilization composition % coverage (printed by a printhead) | | | | | | | | | | |
| coverage | 0 | 20 | 40 | 60 | 80 | 100 | 120 | 140 | 160 | 180 | 200 |
| 5 | 2.5 | 2.5 | 2.5 | 3.5 | 3 | 3.5 | 2.5 | 3 | 3 | 3.5 | 3.5 |
| 20 | 3.5 | 4 | 4 | 4 | 4.5 | 4.5 | 4.5 | 4.5 | 4.5 | 4.5 | 4 |
| 40 | 4 | 4 | 5 | 5 | 4.5 | 5 | 4.5 | 4 | 4.5 | 4.5 | 4.5 |
| 60 | 3.5 | 4 | 5 | 5 | 4.5 | 5 | 4.5 | 4.5 | 4.5 | 4 | 4.5 |
| 80 | 3.5 | 4.5 | 5 | 5 | 5 | 5 | 4 | 4.5 | 4.5 | 4.5 | 4 |
| 100 | 4.5 | 4.5 | 5 | 5 | 5 | 4.5 | 4 | 4.5 | 4.5 | 4 | 4 |

The optimal amount of the digitally jetted functional (immobilizing) composition was determined by convoluting Tables 1 and 2 by multiplication of corresponding table entries to form a combined functional correction values, and the highest combined values were selected to populate the look-up table, presented in Table 3.

Table 3 presents the look-up table having one column for optimal quality and one column for economic optimization.

TABLE 3

| White % | best value | low cost |
|---|---|---|
| 5 | 200 | 60 |
| 20 | 120 | 80 |
| 40 | 60 | 60 |
| 60 | 100 | 40 |
| 80 | 100 | 60 |
| 100 | 80 | 60 |

The LUT for low cost (economic) results was chosen from up to 100% immobilizing composition (economic for using a single printhead), and from lowest % immobilization composition from the three highest scores.

Thereafter, any printed image on the same fabric using the same or similar printing machine, the fabric would be sprayed with 0.16 gr/inch 2 immobilizing composition, and according to the image's specific RIP pertaining to colored ink composition coverage, the LUT will be used to supplement additional immobilizing composition per image area.

### Example 2

A similar procedure to that presented in Example 1 was carried out in order to improve the hand-feel (softness) of printed fabric, using a functional composition comprising a softener. As known in the art, areas that receive more ink composition will result in lower softness of the printed fabric due to more solid pigment particles attached to the fabric.

An amino-modified polysiloxane emulsion (ASR 20 micro by AVCO Israel) softening functional composition was printed on a 100% cotton fabric at 25%, 50% and 75% coverage together with a 240% CMYK ink composition coverage (240% is achieved by printing different colors on the same area).

The functional tests included softness and wash fastness, whereas softness was analyzed by TSA—TISSUE SOFTNESS ANALYZER, and the results were graded from 1 (hard) to 5 (soft) using pristine cotton fabric as a reference. Table 4 presents the look-up table afforded from this test run.

TABLE 4

| % of softening | | Softness |
|---|---|---|
| functional composition | Wash fastness | grade (TSA) |
| 0 | NA | 4.5 |
| (pristine fabric as ref.) | | |
| 25 | 4.5 | 4 |
| 50 | 3 | 4 |
| 75 | 2.5 | 5 |

In order to keep the wash fatness as high as possible and in the time to keep the level of softness, the LUT for this case will be 25% of the functional composition.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

In addition, any priority document(s) of this application is/are hereby incorporated herein by reference in its/their entirety.

1. A method of digital printing an image on a fabric, comprising:
generating a look-up table by printing a gradient pattern on the fabric using at least one inkjet color ink composition and at least one functional composition, said gradient pattern comprises a plurality of areas, each of said areas receive an amount of said color ink composition and an amount of said functional composition;
subjecting the fabric having said gradient pattern thereon to a functional test corresponding to said functional composition, and recording an optimal amount of said functional composition for each amount of said color ink composition, based on optimal result of said functional test, thereby generating said look-up table;
digitally printing the image on the fabric using said at least one color ink composition; and digitally printing an amount of said at least one functional composition on at least a portion of the image, wherein:
said amount of said functional composition is determined for said portion based on an amount of said color ink composition in said portion and said look-up table;
said functional composition comprises at least one functional agent.

2. The method of claim 1, wherein said portion is defined by a raster image processor that controls a printing step of the image.

3. The method of claim 2, wherein said portion of the image is one or more pixels of the image as stored in a raster image processor information.

4. The method of claim 1, wherein said digitally printing the image and said digitally printing said functional composition are effected at a different printing resolution.

5. The method of claim 1, wherein said digitally printing the image and said digitally printing said functional composition are effected essentially concomitantly.

6. The method of claim 5, wherein said digitally printing the image is effected prior to said digitally printing said functional composition.

7. The method of claim 5, wherein said digitally printing the image is effected subsequently to said digitally printing said functional composition.

8. The method of wherein said functional composition is suitable for a digital printhead and essentially devoid of a colorant.

9. The method of claim 1, wherein
said functional agent is selected from the group consisting of a softening agent, an adhesion agent, a rub-resistant agent, a friction-coefficient reducing agent, an optical brightening agent, a fabric-bleaching agent, a cross-linking agent, a dye migration blocking agent, and a matting agent.

10. (canceled)

11. The method of claim 1, wherein said look-up table is generated for a given fabric and/or a given printing machine.

12. The method of claim 11, further comprises, prior to said digitally printing said gradient pattern or the image, uniformly applying at least one functional composition on at least an area of the fabric corresponding to said gradient pattern or the image.

13. The method of claim 12, wherein said uniformly applying is effected at a minimal amount that allows passing a functional test that is different than said functional test.

14. The method of claim 12, further comprising drying said at least one functional composition prior to said digitally printing said gradient pattern or the image.

15. The method of claim 1, wherein digitally printing the image comprises applying an immobilizing composition on the fabric.

16. The method of claim 15, wherein said immobilizing composition is a functional composition.
